(19) United States
(12) Patent Application Publication
(10) Pub. No.: US 2026/0037180 A1
(43) Pub. Date: Feb. 5, 2026

(54) MANAGED MEMORY PERFORMANCE CONTROL

(71) Applicant: Micron Technology, Inc., Boise, ID (US)

(72) Inventors: Nitul Gohain, Bangalore (IN); John E. Maroney, Irvine, CA (US)

(21) Appl. No.: 19/276,789

(22) Filed: Jul. 22, 2025

Related U.S. Application Data
(60) Provisional application No. 63/677,675, filed on Jul. 31, 2024.

(51) Int. Cl. G06F 3/06

(52) U.S. Cl. CPC G06F 3/0656; G06F 3/0604; G06F 3/0659; G06F 3/0679

(57) ABSTRACT

Methods, systems, and devices for single level cell write buffer extension control are described. A host device may indicate a delay to be observed between write operations to a memory system. The memory system may perform random read operations or read operations for garbage collection during these delays, which allow the memory system to allocate space for a write buffer, such as a single-level cell (SLC) write buffer, even when performing a large quantity of write commands as part of a sequential write command. Additionally, by allocating space for the write buffer, the memory system may be able to keep writing to memory cells in accordance with the first write operation type, such as an SLC type, for longer periods of time, which may improve the write speeds and decrease an overall latency associated with sequential write operations.

### CROSS REFERENCE

The present Application for Patent claims priority to U.S. Patent Application No. 63/677,675 by Gohain et al., entitled “MANAGED MEMORY PERFORMANCE CONTROL,” filed Jul. 31, 2024, which is assigned to the assignee hereof, and which is expressly incorporated by reference in its entirety herein.

### TECHNICAL FIELD

The following relates to one or more systems for memory, including single level cell write buffer extension control.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports single level cell write buffer extension control in accordance with examples as disclosed herein.

FIG. 2 shows an example of a system that supports single level cell write buffer extension control in accordance with examples as disclosed herein.

FIG. 3 shows an example of a process flow that supports single level cell write buffer extension control in accordance with examples as disclosed herein.

FIG. 4 shows a block diagram of a memory system that supports single level cell write buffer extension control in accordance with examples as disclosed herein.

FIG. 5 shows a block diagram of a host system that supports single level cell write buffer extension control in accordance with examples as disclosed herein.

FIGS. 6 through 8 show flowcharts illustrating a method or methods that support single level cell write buffer extension control in accordance with examples as disclosed herein.

### DETAILED DESCRIPTION

Some memory systems may perform write operations in accordance with a first write operation type (e.g., single-level cell (SLC) type), which may be associated with relatively higher write speeds compared to other write operation types (e.g., triple-level cell (TLC) types). In some cases, while performing sequential write operations associated with multiple write commands, the memory system may not have time to perform random read operations or read operations as part of garbage collection. For example, bandwidth of an interface between a memory controller and memory devices may be consumed by the sequential write operations. Without performing the read operations, garbage collection or other maintenance operations may not be performed to allocate (e.g., re-allocate, free up) memory locations for a write buffer (e.g., an SLC write buffer). However, write operations according to the first type of write operations may involve writing data to the write buffer. As such, if the write buffer is not available, the memory system may switch to writing to memory cells using other write operation types (e.g., writing to memory cells as TLCs), and random read performance may also be impacted. This may cause a significant drop in performance (e.g., increased latency) associated with write operations for large workloads (e.g., large sequential workloads).

In accordance with examples as described herein, a host device (e.g., a host device on an automotive platform) may indicate a setting (e.g., performance factor) for write operations for a memory system, which may be implemented by the memory system by inserting delays between write operations. The memory system may perform random read operations or read operations for garbage collection during these delays, which may allow the memory system to free up space for a write buffer (e.g., the SLC write buffer) even when performing a large quantity of write commands as part of a sequential write command. Additionally, by allocating space for the write buffer and thereby extending the write buffer, the memory system may be able to keep writing to memory cells in accordance with the first write operation type (e.g., the SLC type) for longer periods of time, which may improve the write speeds and decrease an overall latency associated with sequential write operations (e.g., despite observing delays between write operations).

In addition to applicability in memory systems as described herein, techniques for write buffer extension may be generally implemented to improve the performance of various electronic devices and systems (including solid-state drive (SSD) systems, automotive systems, (e.g., automotive SSDs), artificial intelligence (AI) applications, augmented reality (AR) applications, virtual reality (VR) applications, and gaming). Some electronic device applications, including high-performance applications such as automotive systems, AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving the utilization of an SLC buffer, which may lead to decreased processing and latency, such as while processing sequential write commands, among other benefits. Additionally, the improved utilization of the SLC buffer may support higher quality of service requirements over system operational timeframes, such as input/output (I/O) workloads and random read workloads that may be experienced by automotive systems.

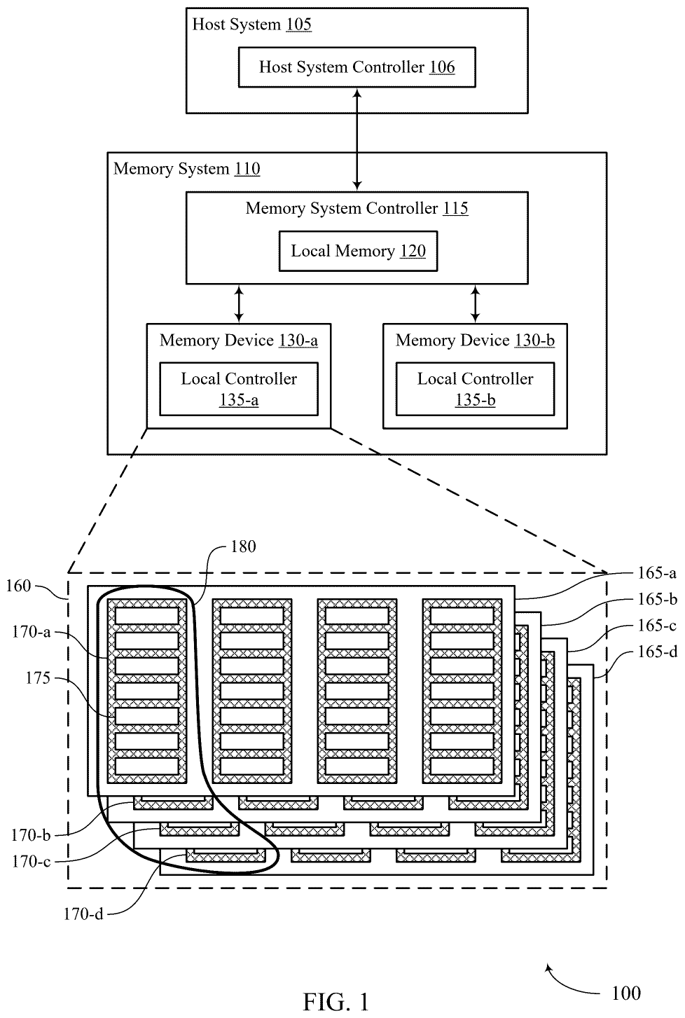

FIG. 1 shows an example of a system 100 that supports single level cell write buffer extension control in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, an SSD, a hard disk drive (HDD), a dual in-line memory module (DIMM), a small outline DIMM (SO-DIMM), or a non-volatile DIMM (NVDIMM), among other devices. In some cases, the memory system 110 may be implemented as part of an automotive system (e.g., as an automotive SSD). For example, the host system 105 may be an example of an automotive host system.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as SLCs. Additionally, or alternatively, a NAND memory device 130 may include memory cells configured to each store multiple bits of information, which may be referred to as multi-level cells (MLCs) if configured to each store two bits of information, as TLCs if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the memory system 110 may perform write operations in accordance with a first write operation type (e.g., an SLC type), which may be associated with relatively higher write speeds compared to other write operation types (e.g., a TLC type, an MLC type, a QLC type). In some cases, while performing a sequential write operation associated with one or more write commands issued by the host system 105, the memory system 110 may not have time to perform random read operations or read operations as part of garbage collection. Without performing the read operations, garbage collection may not be performed to allocate (e.g., re-allocate, free up) memory locations for a write buffer (e.g., an SLC write buffer), which may cause the memory system 110 to switch to writing to memory cells using other write operation types (e.g., as TLCs, MLCs, QLCs), and random read performance may also be impacted. This may cause increased latency associated with write operations, such as for strenuous workloads (e.g., large sequential workloads).

In accordance with examples as described herein, the host system 105 may indicate a performance factor for write operations by the memory system 110, which may be implemented by the memory system by inserting delays between write operations to memory devices 130. The memory system 110 may perform random read operations or read operations as part of one or more maintenance procedures during these delays, which allow the memory system 110 to free up space for a write buffer (e.g., the SLC write buffer, as part of a clearing procedure for the write buffer) even when performing a large quantity of write commands as part of a sequential write command. Additionally, by allocating space for the write buffer, the memory system 110 may be able to keep writing to memory cells at one or more memory devices 130 in accordance with the first write operation type (e.g., the SLC type) for longer periods of time, which may improve the write speeds and decrease an overall latency associated with sequential write operations (e.g., despite observing delays between write operations).

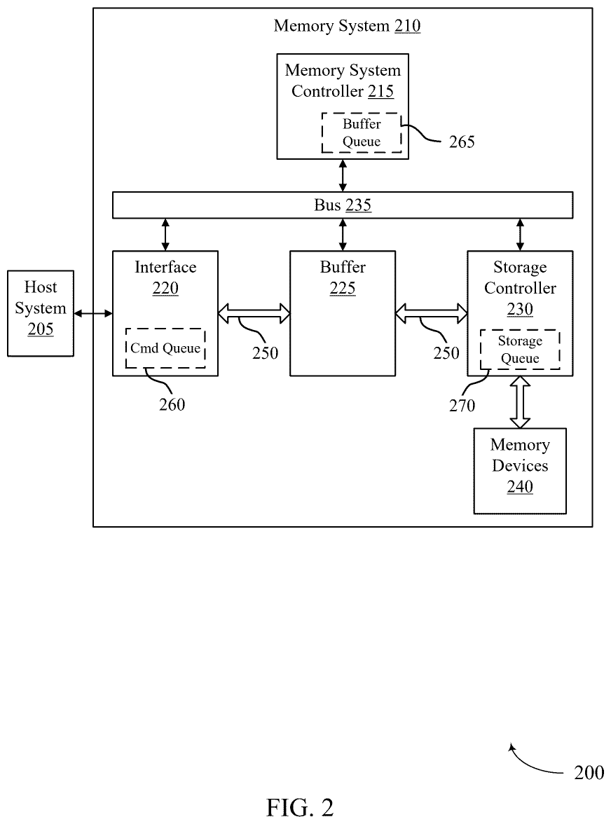

FIG. 2 shows an example of a system 200 that supports single level cell write buffer extension control in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples. In some cases, the memory system 210 may be implemented as part of an automotive system, and the memory system 210 may support capacities and temperatures associated with the automotive system.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In accordance with examples as described herein, the host system 205 may indicate, via one or more commands, one or more settings associated with write operations by the memory system 210. In some examples, the memory system 210 may observe a delay between write operations in accordance with the one or more settings. The memory system 210 may perform random read operations or read operations for garbage collection during these delays, which may allow the memory system 210 to free up space for a write buffer (e.g., the SLC write buffer) even while performing a large quantity of write commands to memory devices 240 as part of a sequential write command. Additionally, by allocating space for the write buffer, the memory system 210 may continue to write to memory cells of one or more memory devices 240 in accordance with the first write operation type (e.g., the SLC type) for longer periods of time, which may improve the write speeds and decrease an overall latency associated with sequential write operations (e.g., despite observing delays between write operations).

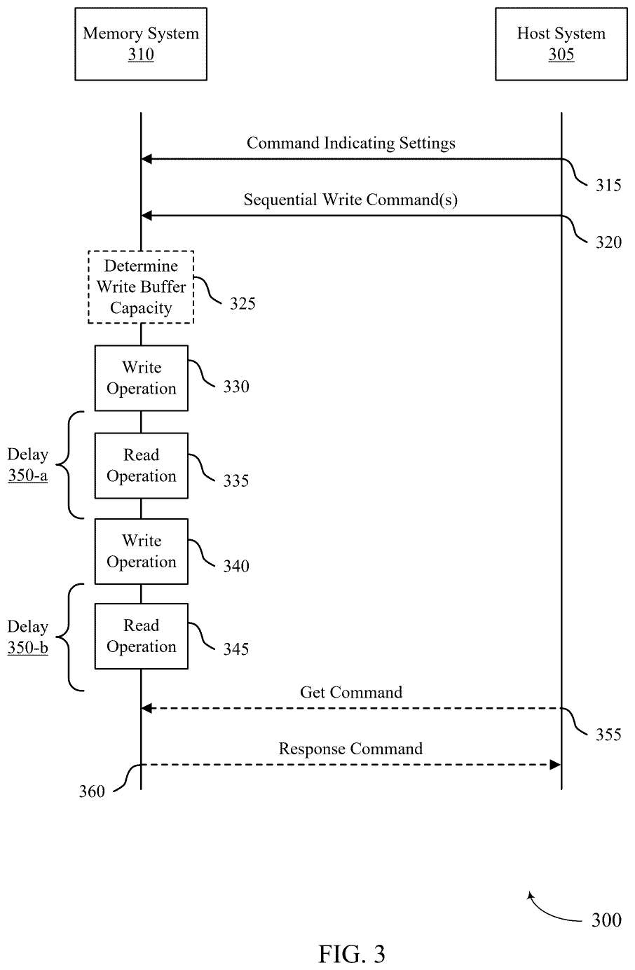

FIG. 3 shows an example of a process flow 300 that supports single level cell write buffer extension control in accordance with examples as disclosed herein. The process flow 300 may implement aspects of the system 100 and the system 200. For example, the memory system 310 may be an example of the memory system 210 and the memory system 110 and the host system 305 may be an example of the host system 105 and the host system 205, as described with reference to FIGS. 1 and 2.

At 315, the host system 305 may output one or more commands indicating one or more settings associated with write operations by the memory system 310. For example, the host system 305 may output a set command (e.g., a vendor-specific command, a command as part of a set feature) that may indicate the one or more settings. The one or more settings may be associated with delays 350 to be observed by the memory system 310 when performing write operations using a first type of write operation (e.g., an SLC type). In some examples, the one or more settings may include a relative performance of sequential write operations performed by the memory system 310. In some cases, a format for the set command may include one or more entries using a plurality of words of the set command, as shown in Table 1.

TABLE 1
Set Command Format

| Word | | | |
|---|---|---|---|
| Offset | Bits | Definition | Function |
| 0 | 31:16 | Command Identifier (CID) | May be set as defined in |
| | | | NVMe Soecification version |
| | | | 2.0a. |
| | 15:14 | PRP or SGL for Data Transfer (PSDT) | May be set to zero |
| | 13:10 | Reserved | May be set to zero |
| | 9:8 | Fused Operation (FUSE) | May be set to zero |
| | 7:0 | Opcode (OPC) | May be set to 09h |
| | | | (OPC Set command = 09h, Get |
| | | | command = 0Ah) |
| 1 | 31:0 | Namespace Identifier (NSID) | May be set to zero |
| 3:2 | 31:0 | Reserved | May be set to zero |
| 5:4 | 31:0 | Metadata Pointer (MPTR) | May be set to zero |
| 9:6 | 31:0 | Data Pointer (DPTR) | May point to the physical |
| | | | contiguous 4KB aligned |
| | | | address containing Not used. |
| 10 | 31 | Save (SV) | May be set to 1b |
| | 30:8 | Reserved | May be set to zero |
| | 7:0 | Feature Identifier (FID) | May be set to E9h |
| 11 | 31:16 | Reserved | May be set to zero |
| 11 | 15:0 | Write Buffer Settings | See Table 2 |
| 12 | 31:0 | Vendor specific | Not Used. |
| 13 | 31:0 | Vendor specific | Not Used. |
| 14 | 31:07 | Reserved | |
| 14 | 06:00 | Universally Unique Identifier Index: | |
| 15 | 31:0 | Vendor Specific | Not Used. |

In some examples, the one or more settings may be indicated by one or more words of the set command shown in Table 1. For example, at least a portion of the word with word offset 11 (e.g., 16 bits thereof) of the set command may be used to indicate the one or more settings, as shown in Table 2. The one or more settings may correspond to a write buffer (e.g., SLC write buffer) extension by implementing one or more delays for write commands using the first type of write operation (e.g., SLC type), which may provide time for the memory system 310 to perform one or more operations (e.g., read operations, garbage collection operations) between write operations (e.g., sequential write operations) to free up space (e.g., allocate space to) the write buffer. Additionally, or alternatively, the one or more settings may correspond to improving random reads by implementing one or more delays to write commands using the second type of write operations (e.g., TLC type), the first type, or both, which may provide additional time for performing random read operations between write operations (e.g., sequential write commands).

TABLE 2
One or more settings for write buffer control.

| | Bits | | | | | | | | | | | | | | | |
|---|---|---|---|---|---|---|---|---|---|---|---|---|---|---|---|---|
| Section | 15 | 14 | 13 | 12 | 11 | 10 | 9 | 8 | 7 | 6 | 5 | 4 | 3 | 2 | 1 | 0 |
| Enable SLC write buffer | | | | | | | | | 0 | x | x | | | | | |
| extension control feature | | | | | | | | | | | | | | | | |
| Disable SLC write buffer | | | | | | | | | 1 | x | x | | | | | |
| extension control feature | | | | | | | | | | | | | | | | |
| Percent SLC cached sequential | | | | | | | | | x | x | x | 100% = 11111b | | | | |
| write performance control | | | | | | | | | | | | in 1/32 | | | | |
| relative to steady state | | | | | | | | | | | | increments | | | | |
| | | | | | | | | | | | | 10% = 00000b | | | | |
| Enable random read steady state | 0 | x | x | | | | | | | | | | | | | |
| write throttle control feature | | | | | | | | | | | | | | | | |
| Disable random read steady | 1 | x | x | | | | | | | | | | | | | |
| state write throttle control | | | | | | | | | | | | | | | | |
| feature | | | | | | | | | | | | | | | | |

| | | | | |
|---|---|---|---|---|
| Percent TLC sequential write | x | x | x | 100% = 11111b |
| performance control relative | | | | in 1/32 |
| to steady state | | | | increments |
| | | | | 10% = 00000b |

In some examples, the bit quantities for each word may be different than those shown in Tables 1 and 2. Additionally, or alternatively, additional entries not shown may be included in Table 1 and 2, or entries shown to be included in the set command may be omitted.

As shown in Table 2, the one or more settings may include an indication of a steady state performance when performing write operations using the first type of write operation, a second type of write operation (e.g., a TLC type), or both. For example, one or more bits may be used to indicate a percentage of a write performance relative to steady state. For instance, indicating 100% performance may correspond to having the same write performance as in steady state (e.g., without any delays), and may be indicated by setting each bit to a value of 1. In this case, the memory system 310 may refrain from implementing any delays for write operations using the corresponding type of write operation (e.g., SLC or TLC), which may maintain 100% performance.

In some cases, the set command may be configured with a lower limit for the indication of the performance control. For example, a lower limit may be 10%, as shown in Table 2, which may be indicated (e.g., by the host system 305) by setting each bit to a value of 0. In some examples, a different lower limit may be chosen than that shown in Table 2. The host system 305 may indicate a value between the lower limit and an upper limit (e.g., 100%) using a combination of bits having values of 1 or 0. As such, the memory system 310 may implement delays 350 in accordance with the indicated percent performance (e.g., to achieve the indicated performance), which may throttle write operations using the first type of write operation, the second type of write operation, or both. For example, indicating a binary value of 11100 for the SLC performance may correspond to a 90.6% performance of write operations relative to steady state (e.g., with no delays), and the memory system 310 may implement delays 350 such that write operations are performed (e.g., approximately, substantially) 90.6% of the time, while delays are implemented for a remainder of the time. Additionally, or alternatively, the performance may correspond to a busy time for an interface between the memory system 310 and the one or more memory devices of the memory system 310. For instance, for a 90.6% performance, the interface may be busy (e.g., substantially) 90.6% of the time (e.g., while performing write operations).

In some examples, the one or more settings may include one or more bits indicating whether features corresponding to the write buffer extension, the random reads, or both, are enabled or disabled, as shown in Table 2. For example, the host system 305 may indicate the memory system 310 that the write buffer extension and random read features are disabled, which may cause the memory system 310 to refrain from implementing delays 350 for any write operations.

In some cases, the set command may also include, using at least one bit, a do-not-retry indication. For example, if set to a first value (e.g., 1), the set command may indicate that if the command fails, and is re-submitted, the command is expected to fail again. If set to a second value (e.g., 0), the set command may indicate the command may succeed if re-submitted. As such, the command may indicate whether the command should be re-tried if failed. Additionally, or alternatively, the set command may include an indication of whether additional status information for the set command is available as part of an error information log, which may be obtained using a Get Log Page command (e.g., output by the host system 305). Additionally, or alternatively, the set command may include a status code type, which may indicate whether a command specified by the Command and Submission Queue has completed. The set command may also include a status code, which may indicate error information or status information for the indicated command (e.g., whether the command completed successfully, whether the command failed).

In some examples, the set command to trigger the memory system 310 to observe the delays 350 may be output by the host system 305 based on a workload of the memory system 310. For example, the host system 305 may determine that a workload of the memory system 310 (e.g., a quantity of operations or a quantity of sequential write commands scheduled for the memory system 310) exceeds a threshold value. Additionally, or alternatively, the host system 305 may output the set command based determining that a quantity of timeouts (e.g., write command timeouts, read command timeouts, or both) experienced or indicated (e.g., via one or more error messages) by the memory system 310 exceed a threshold value. Additionally, or alternatively, the host system 305 may output the set command based on a quantity of read commands (e.g., random read commands, read commands for garbage collection or other management operations) in a storage queue associated with the memory system 310 exceeds a threshold value.

At 320, the host system 305 may output one or more sequential write commands to the memory system 310 associated with respective sets of data. The one or more sequential write commands may correspond to respective write operations to write the respective sets of data to one or more memory devices of the memory system 310.

At 325, the memory system 310 may determine a capacity of the write buffer. In some examples, the memory system 310 may be configured to implement the delays 350 in accordance with the received one or more settings based on the capacity of the write buffer. For example, the memory system 310 may implement the delays 350 in response to determining that a remaining capacity of the write buffer is below a threshold value.

At 330, the memory system 310 may perform a first write operation corresponding to at least a portion of data associated with the one or more sequential write commands. In some examples, the first write operation may be performed according to the first type of write operation. Alternatively, the first write operation may be performed according to the second type of write operation (e.g., the TLC type, the QLC type), such as in cases where the write buffer is at capacity. In some cases, performing the first write operation may include outputting a corresponding first command to the one or more memory devices of the memory system 310 to perform a first write operation, which may correspond to writing a respective set of data corresponding to at least the portion of the one or more sequential write commands to the write buffer.

As described herein, the memory system 310 (e.g., a controller of the memory system 310, such as a memory system controller 215) may implement a delay 350-a following the first write operation. In some examples, the delay 350-a may be implemented (e.g., by the controller) after performing the first write command, and before performing a second write operation corresponding to writing additional data associated with the one or more sequential write commands to the one or more memory devices. Additionally, or alternatively, the delay 350-a may be observed before outputting the second write command from a command queue (e.g., observed between commands in a submission queue, a storage queue 270), or before outputting a second command to the one or more memory devices to write at least a portion of a set of data indicated by the one or more sequential write commands. A duration of the delay 350-a may be based on the one or more settings indicated by the host system 305. For example, the host system 305 may indicate an explicit duration for the delay 350-a. Additionally, or alternatively, the duration may be selected by the memory system 310 based on the indicated performance (e.g., of SLC write operations, of TLC write operations) relative to steady state performance indicated by the one or more settings. For example, in cases where the write operation performed at 330 is an SLC write to the SLC write buffer, the memory system 310 may observe a delay indicated by the Percent SLC cached sequential write performance control relative to steady state setting, whereas if the write operation performed at 330 is a TLC write, the memory system 310 may observe a delay indicated by the Percent TLC sequential write performance control relative to steady state setting.

At 335, the memory system 310 may perform a first read operation during the delay 350-a, based on the one or more settings. For example, the memory system 310 may perform a random read operation, or a read operation as part of a maintenance procedure (e.g., garbage collection, SLC write buffer maintenance). In some examples, the memory system 310 may observe the delay 350-a based on determining that one or more read operations are in a storage queue for the one or more memory devices. For example, if one or more read operations are in the storage queue, the memory system 310 may observe the delay 350-a and perform the first read operation. Alternatively, if the storage queue has no read operations, the memory system 310 may refrain from observing the delay 350-a, and may instead perform a second write operation (e.g., without delay) after performing the first write operation.

At 340, the memory system 310 may perform a second write operation corresponding to a second sequential write command of the one or more sequential write commands. In some examples, the second write operation may be performed according to the first type of write operation based on observing the delay 350-a. For example, the memory system 310 may allocate space to the write buffer during the delay 350-a (e.g., as part of a clearing procedure for the write buffer), which may allow the memory system 310 to perform write operations according to the first type of write operation using the write buffer. In some cases, performing the first write operation may include outputting a corresponding second command to the one or more memory devices of the memory system 310 to perform a second write operation, which may correspond to writing a respective set of data corresponding to the second sequential write command to the write buffer. In some cases, the memory system 310 may output the second command after observing the delay 350-a. Alternatively, the memory system 310 may output the second command during or prior to the delay 350-a, but refrain from performing the second read operation via the one or more memory devices until after the delay 350-a.

At 345, the memory system 310 may perform a second read operation during a delay 350-b, based on the one or more settings. For example, the memory system 310 may perform a random read operation, or a read operation as part of a maintenance procedure (e.g., garbage collection, clearing procedure for the SLC write buffer). In some examples, the memory system 310 may observe the delay 350-a based on determining that one or more read operations are in the storage queue for the one or more memory devices.

At 355, the host system 305 may output a get command, which may be used by the host system 305 to request an indication of the one or more settings currently used by the memory system 310. For example, at 360, the memory system 310 may issue a response command that may indicate at least some of the one or more settings. For example, the response command may indicate whether the write buffer extension or random read features are enabled or disabled, the percentage of the write performance relative to steady state (e.g., for SLC, TLC, or both), or a combination thereof. In some examples, the get command may use a format as shown in Table 3. In some cases, information relating to the one or more settings may be indicated (e.g., by the memory system 310) via one or more bits corresponding to a data pointer, as show in Table 3.

TABLE 3
Command format

| Word Offset | Bits | Definition | Function | |
|---|---|---|---|---|
| 0 | 31:16 | Command Identifier (CID) | May be set as defined in NVMe Specification | |
| | | | version 2.0a. | |
| | 15:14 | PRP or SGL for Data | May be set to zero | |
| | | Transfer (PSDT) | | |
| | 13:10 | Reserved | May be set to zero | |
| | 9:8 | Fused Operation (FUSE) | May be set to zero | |
| | 7:0 | Opcode (OPC) | May be set to 0Ah | |
| | | | (OPC Set features = 09h, Get features = 0Ah) | |
| 1 | 31:0 | Namespace Identifier | May be set to zero | |
| | | (NSID) | | |
| 3:2 | 31:0 | Reserved | May be set to zero | |
| 5:4 | 31:0 | Metadata Pointer (MPTR) | May be set to zero | |
| 9:6 | 31:0 | Data Pointer (DPTR) | May point to the physical contiguous 4KB | |
| | | | aligned address. Additionally, or alternatively, | |
| | | | may be used to indicate the one or more | |
| | | | settings. | |
| 10 | 31:11 | Reserved | May be set to 0b | |
| | 10:8 | SEL | Select | Description |
| | | | 000b | Current |
| | | | 001b | Default |
| | | | 010b | Saved |
| | | | 011b | Supported Capabilities |
| | | | 100b to 111b | Reserved |
| | 7:0 | Feature Identifier (FID) | May be set to E9h | |
| 11 | 31:0 | Reserved | | |
| 14 | 31:07 | Reserved | | |
| 14 | 06:00 | UUID Index: | | |
| All Others | | Reserved | | |

In some cases, the get command, the response command, or both, may also include, using at least one bit, a do-not-retry indication, as described herein. Additionally, or alternatively, the get command, the response command, or both, may include an indication of whether additional status information for the set command is available as part of an error information log, which may be obtained using a Get Log Page command (e.g., output by the host system 305). Additionally, or alternatively, the get command, the response command, or both, may include a status code type, which may indicate whether a command specified by the Command and Submission Queue has completed. The set command may also include a status code, which may indicate error information or status information for the indicated command (e.g., whether the command completed successfully, whether the command failed).

Accordingly, by implementing write buffer extension as described herein, the memory system 310 may support higher utilization of system resources (e.g., host system 305 and memory system 310), may maintain high performance even with high logical saturation (e.g., high usage of logical address space), and may meet higher quality of service requirements over system operational timeframes, which may support performance requirements of automotive systems (e.g., automotive SSDs).

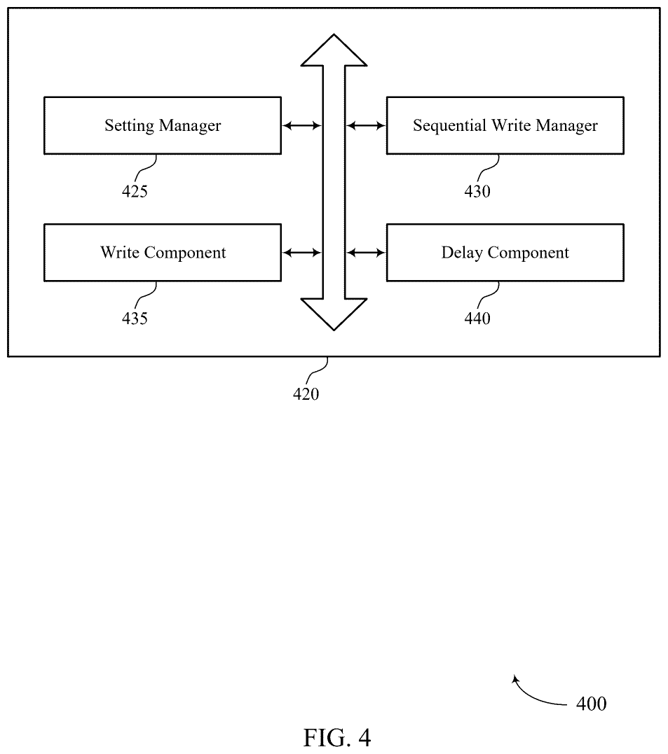

FIG. 4 shows a block diagram 400 of a memory system 420 that supports single level cell write buffer extension control in accordance with examples as disclosed herein. The memory system 420 may be an example of aspects of a memory system as described with reference to FIGS. 1 through 3. The memory system 420, or various components thereof, may be an example of means for performing various aspects of single level cell write buffer extension control as described herein. For example, the memory system 420 may include a setting manager 425, a sequential write manager 430, a write component 435, a delay component 440, or any combination thereof. Each of these components, or components of subcomponents thereof (e.g., one or more processors, one or more memories), may communicate, directly or indirectly, with one another (e.g., via one or more buses). In some examples, the memory system 420 may be implemented as part of an automotive system (e.g., an automotive SSD).

The setting manager 425 may be configured as or otherwise support a means for receiving a command indicating one or more settings associated with write operations. The sequential write manager 430 may be configured as or otherwise support a means for receiving a plurality of sequential write commands associated with respective sets of data. The write component 435 may be configured as or otherwise support a means for performing respective write operations corresponding to writing the respective sets of data to one or more memory devices of the memory system in response to receiving the plurality of sequential write commands. The delay component 440 may be configured as or otherwise support a means for performing, during respective delay durations between one or more of the respective write operations, one or more read operations, where the respective delay durations are based at least in part on the one or more settings.

In some examples, the one or more settings indicate a relative performance of sequential write operations. In some examples, the one or more settings may be associated with a performance of an automotive system.

In some examples, to support performing the respective write operations, the write component 435 may be configured as or otherwise support a means for outputting a first command to the one or more memory devices to perform a first write operation of a plurality of write operations associated with one or more of the plurality of sequential write commands. In some examples, to support performing the respective write operations, the delay component 440 may be configured as or otherwise support a means for outputting a second command to the one or more memory devices after observing a respective delay duration subsequent to outputting the first command, where the second command is associated with performing a second write operation of a plurality of write operations associated with one or more of the plurality of sequential write commands.

In some examples, the delay component 440 may be configured as or otherwise support a means for determining that the one or more read operations are in a storage queue for the one or more memory devices of the memory system, where observing the respective delay durations is in response to the determination that the one or more read operations are in the storage queue.

In some examples, the one or more read operations include random read operations. In some examples, the one or more read operations are associated with a maintenance procedure.

In some examples, the write component 435 may be configured as or otherwise support a means for performing the respective write operations according to a first type of write operation, where performing the respective write operations includes writing the respective sets of data to a write buffer allocated for operation according to the first type of write operation.

In some examples, the first type of write operation includes a single level cell (SLC) type. In some examples, the one or more settings include an indication of a steady state performance when performing write operations using a second type of write operation. In some examples, the second type of write operation includes a triple level cell (TLC) type or a quad level cell (QLC) type.

In some examples, the delay component 440 may be configured as or otherwise support a means for observing the respective delay durations in response to determining that a remaining capacity of the write buffer is below a threshold value.

In some examples, the setting manager 425 may be configured as or otherwise support a means for receive a command indicating one or more settings associated with write operations, the one or more settings indicating a performance metric for a write buffer associated with sequential write commands. In some examples, the sequential write manager 430 may be configured as or otherwise support a means for perform respective write operations corresponding to writing respective sets of data to one or more memory devices of the memory system in response to receiving a plurality of sequential write commands, where the respective write operations are based at least in part on storing the respective sets of data at the write buffer. In some examples, the delay component 440 may be configured as or otherwise support a means for perform, during respective delay durations between one or more of the respective write operations, one or more read operations associated with a clearing procedure for the write buffer based at least in part on the indication of the one or more settings, where a quantity of the one or more read operations performed during the respective delay durations is based at least in part on the performance metric.

In some examples, the delay component 440 may be configured as or otherwise support a means for outputting, from a storage queue for the one or more memory devices, a respective command after observing a respective delay duration.

In some examples, the delay component 440 may be configured as or otherwise support a means for outputting, from a storage queue for the one or more memory devices, a respective command. In some examples, the delay component 440 may be configured as or otherwise support a means for observing a respective delay duration prior to initiating execution of the respective command by the one or more memory devices.

In some examples, the delay component 440 may be configured as or otherwise support a means for determining that the one or more read operations are in a storage queue for the one or more memory devices of the memory system, where observing the respective delay durations is in response to the determination that the one or more read operations are in the storage queue.

In some examples, the write component 435 may be configured as or otherwise support a means for performing the respective write operations according to a first type of write operation. In some examples, the first type of write operation includes a single level cell (SLC) type.

In some examples, the one or more read operations obtain a subset of the respective sets of data, and the write component 435 may be configured as or otherwise support a means for writing the subset of the respective sets of data to the one or more memory devices using a second type of write operation.

In some examples, the second type of write operation includes a triple level cell (TLC) type or a quad level cell (QLC) type. In some examples, the delay component 440 may be configured as or otherwise support a means for observing the respective delay durations in response to determining that a remaining capacity of the write buffer is below a threshold value.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

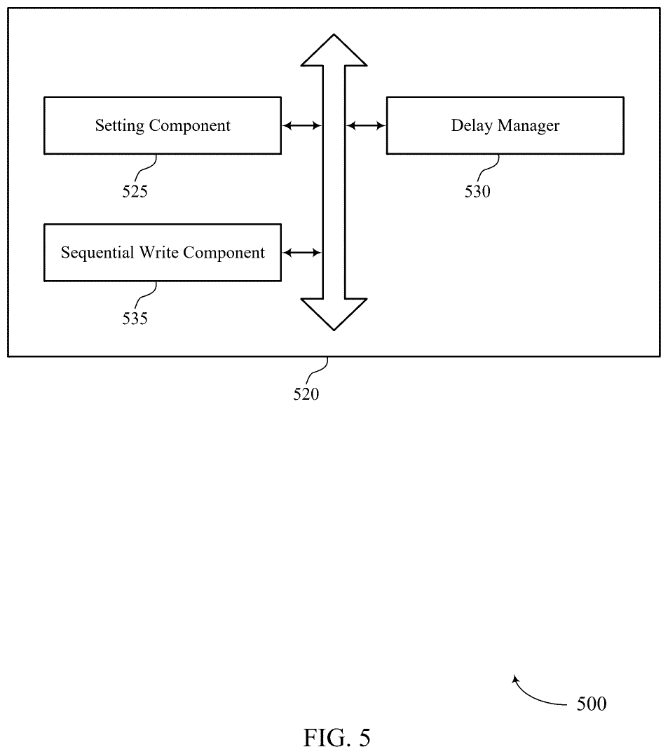

FIG. 5 shows a block diagram 500 of a host system 520 that supports single level cell write buffer extension control in accordance with examples as disclosed herein. The host system 520 may be an example of aspects of a host system as described with reference to FIGS. 1 through 3. The host system 520, or various components thereof, may be an example of means for performing various aspects of single level cell write buffer extension control as described herein. For example, the host system 520 may include a setting component 525, a delay manager 530, a sequential write component 535, or any combination thereof. Each of these components, or components of subcomponents thereof (e.g., one or more processors, one or more memories), may communicate, directly or indirectly, with one another (e.g., via one or more buses).

The setting component 525 may be configured as or otherwise support a means for determining one or more settings for a memory system based at least in part on a workload of the memory system, the workload associated with a quantity of write operations scheduled for the memory system. The delay manager 530 may be configured as or otherwise support a means for outputting a command indicating the one or more settings to the memory system, where the one or more settings are associated with respective delay durations to be observed between write operations. The sequential write component 535 may be configured as or otherwise support a means for outputting an indication of a sequential write operation, the sequential write operation corresponding to a set of data for writing to one or more memory devices of the memory system in accordance with the one or more settings.

In some examples, the setting component 525 may be configured as or otherwise support a means for determining that the workload of the memory system exceeds a threshold value, where outputting the command indicating the one or more settings is in response to the workload exceeding the threshold value.

In some examples, the setting component 525 may be configured as or otherwise support a means for determining that a quantity of timeouts associated with one or more read operations exceeds a threshold value, where outputting the command indicating the one or more settings is in response to the quantity of timeouts exceeding the threshold value.

In some examples, the setting component 525 may be configured as or otherwise support a means for determining that a quantity of read commands in a storage queue associated with the memory system exceeds a threshold value, where outputting the command indicating the one or more settings is in response to the quantity of read commands in the storage queue exceeding the threshold value.

In some examples, the one or more settings include an indication of a steady state performance when performing write operations using a first type of write operation. In some examples, the first type of write operation includes a single level cell (SLC) type or a triple level cell (TLC) type.

In some examples, the delay manager 530 may be configured as or otherwise support a means for outputting a get command to request one or more current settings from the memory system. In some examples, the delay manager 530 may be configured as or otherwise support a means for receiving an indication of the one or more current settings from the memory system in response to the get command, the one or more current settings including a first delay length.

In some examples, the delay manager 530 may be configured as or otherwise support a means for outputting the command to update a length of the respective delay durations to be observed from the first delay length to a second delay length.

In some examples, the described functionality of the host system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 520, or various components thereof, may be implemented at least in part by instructions (e.g., stored in memory, non-transitory computer-readable medium) executable by such at least one processor.

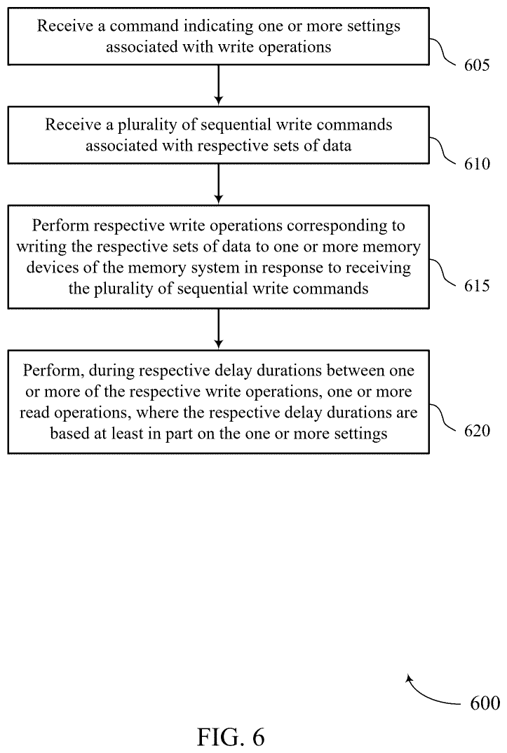

FIG. 6 shows a flowchart illustrating a method 600 that supports single level cell write buffer extension control in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving a command indicating one or more settings associated with write operations. In some examples, aspects of the operations of 605 may be performed by a setting manager 425 as described with reference to FIG. 4.

At 610, the method may include receiving a plurality of sequential write commands associated with respective sets of data. In some examples, aspects of the operations of 610 may be performed by a sequential write manager 430 as described with reference to FIG. 4.

At 615, the method may include performing respective write operations corresponding to writing the respective sets of data to one or more memory devices of the memory system in response to receiving the plurality of sequential write commands. In some examples, aspects of the operations of 615 may be performed by a write component 435 as described with reference to FIG. 4.

At 620, the method may include performing, during respective delay durations between one or more of the respective write operations, one or more read operations, where the respective delay durations are based at least in part on the one or more settings. In some examples, aspects of the operations of 620 may be performed by a delay component 440 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a command indicating one or more settings associated with write operations; receiving a plurality of sequential write commands associated with respective sets of data; performing respective write operations corresponding to writing the respective sets of data to one or more memory devices of the memory system in response to receiving the plurality of sequential write commands; and performing, during respective delay durations between one or more of the respective write operations, one or more read operations, where the respective delay durations are based at least in part on the one or more settings.

Aspect 2: The method, apparatus, or non-transitory computer-readable medium of aspect 1, where the one or more settings indicate a relative performance of sequential write operations.

Aspect 3: The method, apparatus, or non-transitory computer-readable medium of aspect 1, where the one or more settings indicate a performance associated with an automotive system.

Aspect 4: The method, apparatus, or non-transitory computer-readable medium of any of aspects 1 through 2, where performing the respective write operations includes operations, features, circuitry, logic, means, or instructions, or any combination thereof for outputting a first command to the one or more memory devices to perform a first write operation of a plurality of write operations associated with one or more of the plurality of sequential write commands and outputting a second command to the one or more memory devices after observing a respective delay duration subsequent to outputting the first command, where the second command is associated with performing a second write operation of a plurality of write operations associated with one or more of the plurality of sequential write commands.

Aspect 5: The method, apparatus, or non-transitory computer-readable medium of any of aspects 1 through 4, further including operations, features, circuitry, logic, means, or instructions, or any combination thereof for determining that the one or more read operations are in a storage queue for the one or more memory devices of the memory system, where observing the respective delay durations is in response to the determination that the one or more read operations are in the storage queue.

Aspect 6: The method, apparatus, or non-transitory computer-readable medium of any of aspects 1 through 5, where the one or more read operations include random read operations.

Aspect 7: The method, apparatus, or non-transitory computer-readable medium of any of aspects 1 through 6, where the one or more read operations are associated with a maintenance procedure.

Aspect 8: The method, apparatus, or non-transitory computer-readable medium of any of aspects 1 through 7, further including operations, features, circuitry, logic, means, or instructions, or any combination thereof for performing the respective write operations according to a first type of write operation, where performing the respective write operations includes writing the respective sets of data to a write buffer allocated for operation according to the first type of write operation.

Aspect 9: The method, apparatus, or non-transitory computer-readable medium of aspect 8, where the first type of write operation includes a single level cell (SLC) type.

Aspect 10: The method, apparatus, or non-transitory computer-readable medium of any of aspects 8 through 9, where the one or more settings include an indication of a steady state performance when performing write operations using a second type of write operation.

Aspect 11: The method, apparatus, or non-transitory computer-readable medium of aspect 10, where the second type of write operation includes a triple level cell (TLC) type or a quad level cell (QLC) type.

Aspect 12: The method, apparatus, or non-transitory computer-readable medium of any of aspects 8 through 11, further including operations, features, circuitry, logic, means, or instructions, or any combination thereof for observing the respective delay durations in response to determining that a remaining capacity of the write buffer is below a threshold value.

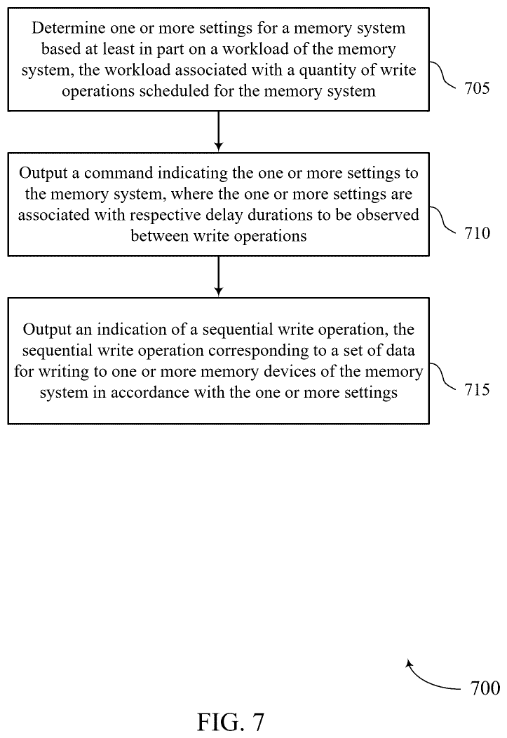

FIG. 7 shows a flowchart illustrating a method 700 that supports single level cell write buffer extension control in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the host system may perform aspects of the described functions using special-purpose hardware.

At 705, the method may include determining one or more settings for a memory system based at least in part on a workload of the memory system, the workload associated with a quantity of write operations scheduled for the memory system. In some examples, aspects of the operations of 705 may be performed by a setting component 525 as described with reference to FIG. 5.

At 710, the method may include outputting a command indicating the one or more settings to the memory system, where the one or more settings are associated with respective delay durations to be observed between write operations. In some examples, aspects of the operations of 710 may be performed by a delay manager 530 as described with reference to FIG. 5.

At 715, the method may include outputting an indication of a sequential write operation, the sequential write operation corresponding to a set of data for writing to one or more memory devices of the memory system in accordance with the one or more settings. In some examples, aspects of the operations of 715 may be performed by a sequential write component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for determining one or more settings for a memory system based at least in part on a workload of the memory system, the workload associated with a quantity of write operations scheduled for the memory system; outputting a command indicating the one or more settings to the memory system, where the one or more settings are associated with respective delay durations to be observed between write operations; and outputting an indication of a sequential write operation, the sequential write operation corresponding to a set of data for writing to one or more memory devices of the memory system in accordance with the one or more settings.

Aspect 14: The method, apparatus, or non-transitory computer-readable medium of aspect 13, further including operations, features, circuitry, logic, means, or instructions, or any combination thereof for determining that the workload of the memory system exceeds a threshold value, where outputting the command indicating the one or more settings is in response to the workload exceeding the threshold value.

Aspect 15: The method, apparatus, or non-transitory computer-readable medium of any of aspects 13 through 14, further including operations, features, circuitry, logic, means, or instructions, or any combination thereof for determining that a quantity of timeouts associated with one or more read operations exceeds a threshold value, where outputting the command indicating the one or more settings is in response to the quantity of timeouts exceeding the threshold value.

Aspect 16: The method, apparatus, or non-transitory computer-readable medium of any of aspects 13 through 15, further including operations, features, circuitry, logic, means, or instructions, or any combination thereof for determining that a quantity of read commands in a storage queue associated with the memory system exceeds a threshold value, where outputting the command indicating the one or more settings is in response to the quantity of read commands in the storage queue exceeding the threshold value.

Aspect 17: The method, apparatus, or non-transitory computer-readable medium of any of aspects 13 through 16, where the one or more settings include an indication of a steady state performance when performing write operations using a first type of write operation.

Aspect 18: The method, apparatus, or non-transitory computer-readable medium of aspect 17, where the first type of write operation includes a single level cell (SLC) type or a triple level cell (TLC) type.

Aspect 19: The method, apparatus, or non-transitory computer-readable medium of any of aspects 13 through 18, further including operations, features, circuitry, logic, means, or instructions, or any combination thereof for outputting a get command to request one or more current settings from the memory system and receiving an indication of the one or more current settings from the memory system in response to the get command, the one or more current settings including a first delay length.

Aspect 20: The method, apparatus, or non-transitory computer-readable medium of aspect 19, further including operations, features, circuitry, logic, means, or instructions, or any combination thereof for outputting the command to update a length of the respective delay durations to be observed from the first delay length to a second delay length.

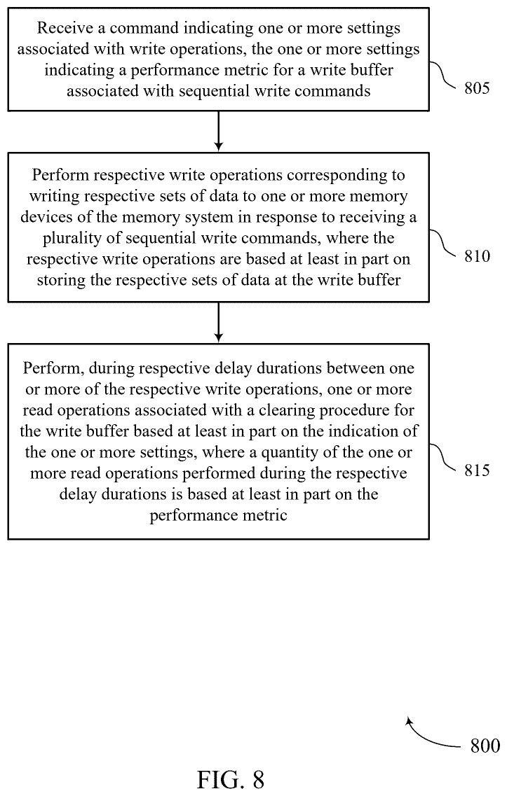

FIG. 8 shows a flowchart illustrating a method 800 that supports single level cell write buffer extension control in accordance with examples as disclosed herein. The operations of method 800 may be implemented by a memory system or its components as described herein. For example, the operations of method 800 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 805, the method may include receive a command indicating one or more settings associated with write operations, the one or more settings indicating a performance metric for a write buffer associated with sequential write commands. In some examples, aspects of the operations of 805 may be performed by a setting manager 425 as described with reference to FIG. 4.

At 810, the method may include perform respective write operations corresponding to writing respective sets of data to one or more memory devices of the memory system in response to receiving a plurality of sequential write commands, where the respective write operations are based at least in part on storing the respective sets of data at the write buffer. In some examples, aspects of the operations of 810 may be performed by a sequential write manager 430 as described with reference to FIG. 4.

At 815, the method may include perform, during respective delay durations between one or more of the respective write operations, one or more read operations associated with a clearing procedure for the write buffer based at least in part on the indication of the one or more settings, where a quantity of the one or more read operations performed during the respective delay durations is based at least in part on the performance metric. In some examples, aspects of the operations of 815 may be performed by a delay component 440 as described with reference to FIG. 4.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 21: A method, apparatus, or non-transitory computer-readable medium including operations, features, circuitry, logic, means, or instructions, or any combination thereof for receive a command indicating one or more settings associated with write operations, the one or more settings indicating a performance metric for a write buffer associated with sequential write commands; perform respective write operations corresponding to writing respective sets of data to one or more memory devices of the memory system in response to receiving a plurality of sequential write commands, where the respective write operations are based at least in part on storing the respective sets of data at the write buffer; and perform, during respective delay durations between one or more of the respective write operations, one or more read operations associated with a clearing procedure for the write buffer based at least in part on the indication of the one or more settings, where a quantity of the one or more read operations performed during the respective delay durations is based at least in part on the performance metric.

Aspect 22: The method, apparatus, or non-transitory computer-readable medium of aspect 21, further including operations, features, circuitry, logic, means, or instructions, or any combination thereof for outputting, from a storage queue for the one or more memory devices, a respective command after observing a respective delay duration.

Aspect 23: The method, apparatus, or non-transitory computer-readable medium of any of aspects 21 through 22, further including operations, features, circuitry, logic, means, or instructions, or any combination thereof for outputting, from a storage queue for the one or more memory devices, a respective command and observing a respective delay duration prior to initiating execution of the respective command by the one or more memory devices.

Aspect 24: The method, apparatus, or non-transitory computer-readable medium of any of aspects 21 through 23, further including operations, features, circuitry, logic, means, or instructions, or any combination thereof for determining that the one or more read operations are in a storage queue for the one or more memory devices of the memory system, where observing the respective delay durations is in response to the determination that the one or more read operations are in the storage queue.

Aspect 25: The method, apparatus, or non-transitory computer-readable medium of any of aspects 21 through 24, further including operations, features, circuitry, logic, means, or instructions, or any combination thereof for performing the respective write operations according to a first type of write operation.

Aspect 26: The method, apparatus, or non-transitory computer-readable medium of aspect 25, where the first type of write operation includes a single level cell (SLC) type.

Aspect 27: The method, apparatus, or non-transitory computer-readable medium of any of aspects 25 through 26, where the one or more read operations obtain a subset of the respective sets of data and the method, apparatuses, and non-transitory computer-readable medium further includes operations, features, circuitry, logic, means, or instructions, or any combination thereof for writing the subset of the respective sets of data to the one or more memory devices using a second type of write operation.

Aspect 28: The method, apparatus, or non-transitory computer-readable medium of aspect 27, where the second type of write operation includes a triple level cell (TLC) type or a quad level cell (QLC) type.

Aspect 29: The method, apparatus, or non-transitory computer-readable medium of any of aspects 21 through 28, further including operations, features, circuitry, logic, means, or instructions, or any combination thereof for observing the respective delay durations in response to determining that a remaining capacity of the write buffer is below a threshold value.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a command indicating one or more settings associated with write operations;
receive a plurality of sequential write commands associated with respective sets of data;
perform respective write operations corresponding to writing the respective sets of data to one or more memory devices of the memory system in response to receiving the plurality of sequential write commands; and
perform, during respective delay durations between one or more of the respective write operations, one or more read operations, wherein the respective delay durations are based at least in part on the one or more settings.

2. The memory system of claim 1, wherein the one or more settings indicate a relative performance of sequential write operations.

3. The memory system of claim 1, wherein performing the respective write operations comprises the processing circuitry configured to cause the memory system to:
output a first command to the one or more memory devices to perform a first write operation of a plurality of write operations associated with one or more of the plurality of sequential write commands; and
output a second command to the one or more memory devices after observing a respective delay duration subsequent to outputting the first command, wherein the second command is associated with performing a second write operation of a plurality of write operations associated with one or more of the plurality of sequential write commands.

4. The memory system of claim 1, wherein the processing circuitry is further configured to cause the memory system to:
determine that the one or more read operations are in a storage queue for the one or more memory devices of the memory system, wherein observing the respective delay durations is in response to the determination that the one or more read operations are in the storage queue.

5. The memory system of claim 1, wherein the one or more read operations comprise random read operations.

6. The memory system of claim 1, wherein the one or more read operations are associated with a maintenance procedure.

7. The memory system of claim 1, wherein the processing circuitry is further configured to cause the memory system to:
perform the respective write operations according to a first type of write operation, wherein performing the respective write operations comprises writing the respective sets of data to a write buffer allocated for operation according to the first type of write operation.

8. The memory system of claim 7, wherein the first type of write operation comprises a single level cell (SLC) type.

9. The memory system of claim 7, wherein the one or more settings comprise an indication of a steady state performance when performing write operations using a second type of write operation.

10. The memory system of claim 9, wherein the second type of write operation comprises a triple level cell (TLC) type or a quad level cell (QLC) type.

11. The memory system of claim 7, wherein the processing circuitry is further configured to cause the memory system to:
observe the respective delay durations in response to determining that a remaining capacity of the write buffer is below a threshold value.

12. The memory system of claim 1, wherein the one or more settings indicate a performance associated with an automotive system.

13. A host system, comprising:
one or more interfaces comprising one or more signal paths operable for communications with one or more memory systems; and
processing circuitry coupled with the one or more interfaces and configured to cause the host system to:
determine one or more settings for a memory system based at least in part on a workload of the memory system, the workload associated with a quantity of write operations scheduled for the memory system;
output a command indicating the one or more settings to the memory system, wherein the one or more settings are associated with respective delay durations to be observed between write operations; and
output an indication of a sequential write operation, the sequential write operation corresponding to a set of data for writing to one or more memory devices of the memory system in accordance with the one or more settings.

14. The host system of claim 13, wherein the processing circuitry is further configured to cause the host system to:
determine that the workload of the memory system exceeds a threshold value, wherein outputting the command indicating the one or more settings is in response to the workload exceeding the threshold value.

15. The host system of claim 13, wherein the processing circuitry is further configured to cause the host system to:
determine that a quantity of timeouts associated with one or more read operations exceeds a threshold value, wherein outputting the command indicating the one or more settings is in response to the quantity of timeouts exceeding the threshold value.

16. The host system of claim 13, wherein the processing circuitry is further configured to cause the host system to:
determine that a quantity of read commands in a storage queue associated with the memory system exceeds a threshold value, wherein outputting the command indicating the one or more settings is in response to the quantity of read commands in the storage queue exceeding the threshold value.

17. The host system of claim 13, wherein the one or more settings comprise an indication of a steady state performance when performing write operations using a first type of write operation.

18. The host system of claim 17, wherein the first type of write operation comprises a single level cell (SLC) type or a triple level cell (TLC) type.

19. The host system of claim 13, wherein the processing circuitry is further configured to cause the host system to:
output a get command to request one or more current settings from the memory system; and
receive an indication of the one or more current settings from the memory system in response to the get command, the one or more current settings comprising a first delay length.

20. The host system of claim 19, wherein the processing circuitry is further configured to cause the host system to:
output the command to update a length of the respective delay durations to be observed from the first delay length to a second delay length.

21. A memory system, comprising:
one or more memory devices; and
processing circuitry coupled with the one or more memory devices and configured to cause the memory system to:
receive a command indicating one or more settings associated with write operations, the one or more settings indicating a performance metric for a write buffer associated with sequential write commands;
perform respective write operations corresponding to writing respective sets of data to one or more memory devices of the memory system in response to receiving a plurality of sequential write commands, wherein the respective write operations are based at least in part on storing the respective sets of data at the write buffer; and
perform, during respective delay durations between one or more of the respective write operations, one or more read operations associated with a clearing procedure for the write buffer based at least in part on the indication of the one or more settings, wherein a quantity of the one or more read operations performed during the respective delay durations is based at least in part on the performance metric.

22. The memory system of claim 21, wherein the processing circuitry is further configured to cause the memory system to:
output, from a storage queue for the one or more memory devices, a respective command after observing a respective delay duration.

23. The memory system of claim 21, wherein the processing circuitry is further configured to cause the memory system to:
output, from a storage queue for the one or more memory devices, a respective command; and
observe a respective delay duration prior to initiating execution of the respective command by the one or more memory devices.

24. The memory system of claim 21, wherein the processing circuitry is further configured to cause the memory system to:
determine that the one or more read operations are in a storage queue for the one or more memory devices of the memory system, wherein observing the respective delay durations is in response to the determination that the one or more read operations are in the storage queue.

25. The memory system of claim 21, wherein the processing circuitry is further configured to cause the memory system to:
perform the respective write operations according to a first type of write operation.

26. The memory system of claim 25, wherein the first type of write operation comprises a single level cell (SLC) type.

27. The memory system of claim 25, wherein the one or more read operations obtain a subset of the respective sets of data, and the processing circuitry is further configured to cause the memory system to:
write the subset of the respective sets of data to the one or more memory devices using a second type of write operation.

28. The memory system of claim 21, wherein the processing circuitry is further configured to cause the memory system to:
observe the respective delay durations in response to determining that a remaining capacity of the write buffer is below a threshold value.

29. A method by a memory system, comprising:
receiving a command indicating one or more settings associated with write operations;
receiving a plurality of sequential write commands associated with respective sets of data;
performing respective write operations corresponding to writing the respective sets of data to one or more memory devices of the memory system in response to receiving the plurality of sequential write commands; and
performing, during respective delay durations between one or more of the respective write operations, one or more read operations, wherein the respective delay durations are based at least in part on the one or more settings.

30. A method by a host system, comprising:
determining one or more settings for a memory system based at least in part on a workload of the memory system, the workload associated with a quantity of write operations scheduled for the memory system;
outputting a command indicating the one or more settings to the memory system, wherein the one or more settings are associated with respective delay durations to be observed between write operations; and
outputting an indication of a sequential write operation, the sequential write operation corresponding to a set of data for writing to one or more memory devices of the memory system in accordance with the one or more settings.
